(19) United States
(12) Patent Application Publication
(10) Pub. No.: US 2025/0224999 A1
(43) Pub. Date: Jul. 10, 2025

(54) CONVERGED INFRASTRUCTURE SYSTEM, NON-VOLATILE MEMORY SYSTEM, AND MEMORY RESOURCE ACQUISITION METHOD

(71) Applicant: SUZHOU METABRAIN INTELLIGENT TECHNOLOGY CO.,, Suzhou (CN)

(72) Inventor: Zhengfeng YUAN, Suzhou (CN)

(21) Appl. No.: 19/094,707

(22) Filed: Mar. 28, 2025

Related U.S. Application Data
(63) Continuation of application No. PCT/CN2023/139249, filed on Dec. 15, 2023.

(30) Foreign Application Priority Data
Apr. 24, 2023 (CN) 202310444139.4

(51) Int. Cl. G06F 9/50; G06F 13/40

(52) U.S. Cl. CPC G06F 9/5083; G06F 9/5016; G06F 13/4022

(57) ABSTRACT

A non-transitory storage system is constructed based on the converged architecture system and includes: a plurality computing nodes in a computing resource pool, an adapter board, and a plurality of solid-state drives configured to establish a communication connection with the plurality of computing nodes through the adapter board to expand a storage resource pool. Through the foregoing design, the storage resource pool is expanded based on the third-generation converged architecture system and a bus interconnection technology, to achieve remote expansion of storage. In addition, the plurality of computing nodes share decoupled storage resources, thereby solving the problems that a storage capacity of conventional Just a Bunch of Flash (JBOF) may only be expanded to a limited extent and remote decoupled access to storage resources by a plurality of hosts is not capable to be achieved.

### CROSS-REFERENCE TO RELATED APPLICATION

This application claims the priority of the Chinese Patent application filed on Apr. 24, 2023 before the CNIPA, China National Intellectual Property Administration with the application number of 202310444139.4, and the title of “CONVERGED ARCHITECTURE SYSTEM, NON-TRANSITORY STORAGE SYSTEM, AND METHOD FOR ACQUIRING STORAGE RESOURCE”, which is incorporated herein in its entirety by reference.

### FIELD

The present application relates to the field of computer technologies and more particularly, to a converged architecture system, a non-transitory storage system, a method for acquiring a storage resource, an apparatus for acquiring a storage resource, an electronic device, and a non-transitory computer-readable storage medium.

### BACKGROUND

The continuous development of informatization is an important driving force for the evolution and progress of storage devices. With the rapid development of digital transformation of enterprises around the world, data is expected to grow exponentially. The development of emerging technologies, such as big data, cloud computing, artificial intelligence, and 5G communications, also increases the complexity and diversity of data sources and structures. New products, new models, and new experiences based on data are constantly emerging, and data has become one of the most important assets of enterprises.

In the related art, a storage capacity of a storage device is relatively fixed and may only be expanded to a limited extent, and remote decoupled access to storage resources by a plurality of hosts (computing nodes) is not capable to be achieved, leading to uneven utilization of storage resources of servers and an inability to balance load.

### SUMMARY

In view of the foregoing problem, embodiments of the present application provide a converged architecture system, a non-transitory storage system, a method for acquiring a storage resource, an apparatus for acquiring a storage resource, an electronic device, and a non-transitory computer-readable storage medium, to overcome the foregoing problems or at least solve some of the foregoing problems.

The embodiments of the present application provide a converged architecture system, which includes a computing resource pool, a memory resource pool, a graphics processing unit resource pool, a heterogeneous accelerator resource pool, and a storage resource pool constructed based on a solid-state drive.

The computing resource pool is connected to the memory resource pool over a first switching network for communication.

The computing resource pool, the graphics processing unit resource pool, the storage resource pool, and the heterogeneous accelerator resource pool are connected to each other over a second switching network for communication.

In some embodiments of the present application, the computing resource pool, the graphics processing unit resource pool, the storage resource pool, and the heterogeneous accelerator resource pool are connected to each other over the second switching network for communication in following ways:
the computing resource pool is connected to the second switching network via a first bus, and is connected to the graphics processing unit resource pool, the storage resource pool, and the heterogeneous accelerator resource pool via the second switching network;
the graphics processing unit resource pool is connected to the second switching network via a second bus, and is connected to the computing resource pool, the storage resource pool, and the heterogeneous accelerator resource pool via the second switching network;
the storage resource pool is connected to the second switching network via a third bus, and is connected to the computing resource pool, the graphics processing unit resource pool, and the heterogeneous accelerator resource pool via the second switching network; and
the heterogeneous accelerator resource pool is connected to the second switching network via a fourth bus, and is connected to the computing resource pool, the graphics processing unit resource pool, and the storage resource pool via the second switching network.

In some embodiments of the present application, the computing resource pool includes a near-end memory, and the memory resource pool includes a remote memory.

In some embodiments of the present application, the first switching network includes a plurality of first switching chips, and any two first switching chips of two layers are interconnected; and/or, the second switching network includes a plurality of second switching chips, any two second switching chips of the two layers are interconnected, and central processing units in the computing resource pool are interconnected via a fast channel interconnection bus.

In some embodiments of the present application, a remote memory of the memory resource pool is expanded over the first switching network.

In some embodiments of the present application, a network offload acceleration chip is connected to the converged architecture system over the second switching network for communication.

In some embodiments of the present application, the network offload acceleration chip is connected to the converged architecture system over the second switching network for communication in following ways:

the network offload acceleration chip is connected to the second switching network via a fifth bus, and is connected to the computing resource pool, the memory resource pool, the graphics processing unit resource pool, the heterogeneous accelerator resource pool, and the storage resource pool via the second switching network.

In some embodiments of the present application, the first switching network is a Compute Express Link (CXL) Fabric switching network, the second switching network is a Peripheral Component Interconnect Express (PCIE) Input/output (I/O) Fabric switching network, the storage resource pool is a Non-Volatile Memory Express (NVME) solid-state drive (SSD) storage resource pool, and the first bus and/or the second bus and/or the third bus and/or the fourth bus are PCIE GEN5 buses.

An embodiment of the present application provides a non-transitory storage system, constructed based on the converged architecture system mentioned above and including:
a plurality of computing nodes in the computing resource pool, an adapter board, and a plurality of solid-state drives;
wherein the plurality of solid-state drives are configured to establish a communication connection with the plurality of computing nodes through the adapter board to expand the storage resource pool.

In some embodiments of the present application, further including:
a sixth bus;
wherein the sixth bus is configured to establish a physical link between the solid-state drives and the adapter board, and a quantity of data lanes in the physical link is determined based on a quantity of solid-state drives that need to be supported.

In some embodiments of the present application, the second switching network is a two-tier CLOS topology architecture;

the plurality of computing nodes are central processing unit nodes; and
each of the central processing unit nodes is configured to transmit a PCIE signal to another central processing unit node over the second switching network, to achieve full interconnection and non-blocking transmission of PCIE resources between the central processing unit nodes.

In some embodiments of the present application,
the plurality of computing nodes belong to a plurality of computing platforms, respectively; and
the central processing unit node belonging to a first computing platform is configured to transmit the PCIE signal to the central processing unit node belonging to a second computing platform over the second switching network.

In some embodiments of the present application, further including:
a first cable;
wherein the first cable is configured to transmit the PCIE signal transmitted via the sixth bus to the storage resource pool.

In some embodiments of the present application, further including:
a signal conditioning component;
wherein the signal conditioning component is configured to re-construct the PCIE signal transmitted via the first cable based on an internal clock to increase transmission energy of the PCIE signal.

In some embodiments of the present application,
the signal conditioning component is deployed with a signal enhancement chip; and
the signal enhancement chip is configured to split the PCIE signal into a plurality of combinations of signal channels.

In some embodiments of the present application, further including:
a second cable;
wherein the second cable is configured to acquire a re-constructed PCIE signal and transmit the re-constructed PCIE signal to a drive backplane of the solid-state drive.

In some embodiments of the present application, the storage resource pool includes any one or combination of followings:
an NVME SSD storage resource pool based on a U.2 form factor and an NVME SSD storage resource pool based on an E3.S form factor.

An embodiment of the present application further provides a method for acquiring a storage resource, applied to the non-transitory storage system mentioned above and including:
acquiring, by the plurality of computing nodes, PCIE resources stored in the storage resource pool by accessing the storage resource pool, to achieve multi-computing node sharing of the PCIE resources.

In some embodiments of the present application, the method further includes:
automatically adjusting, by the storage resource pool, load of the storage resource pool in real time during operation of the system, to achieve load balancing of the storage resource pool.

In some embodiments of the present application, the method further includes:
monitoring resource requirements of the plurality of computing nodes for PCIE resources in real time.

An embodiment of the present application further provides an apparatus for acquiring a storage resource, applied to the non-transitory storage system mentioned above and including:
an access and acquisition module, configured to acquire PCIE resources stored in the storage resource pool by accessing the storage resource pool, to achieve multi-computing node sharing of the PCIE resources.

In some embodiments of the present application, the apparatus further includes:
a load balancing module, configured to control the storage resource pool to automatically adjust its own load in real time during operation of the system, to achieve load balancing of the storage resource pool.

In some embodiments of the present application, the apparatus further includes:
a monitoring module, configured to monitor resource requirements of the plurality of computing nodes for PCIE resources in real time.

An embodiment of the present application further provides an electronic device, including: a processor, a memory, and a computer program stored in the memory and capable of running on the processor, the processor executing the computer program to implement the steps of the method for acquiring a storage resource mentioned above.

An embodiment of the present application further provides a non-transitory computer-readable storage medium, having a computer program stored therein, a processor executing the computer program to implement the steps of the method for acquiring a storage resource mentioned above.

The embodiments of the present application have the following advantages:

The embodiments of the present application provide the converged architecture system and the non-transitory storage system constructed based on the converged architecture system. The converged architecture system includes the computing resource pool, the memory resource pool, the graphics processing unit resource pool, the heterogeneous accelerator resource pool, and the storage resource pool constructed based on the solid-state drive. The computing resource pool is connected to the memory resource pool over the first switching network for communication. The computing resource pool, the graphics processing unit resource pool, the storage resource pool, and the heterogeneous accelerator resource pool are connected to each other over the second switching network for communication. Through the foregoing design, large-scale resource pool decoupling may be achieved, and multi-host sharing and dynamic allocation of resources may also be achieved. The resource pool may be allocated to a plurality of users as needed, and meanwhile, the resources may be easily expanded to increase the capacity of the resource pool. Further, the computing resource pool is connected to the memory resource pool over the first switching network, thereby achieving memory resource pooling and multi-host non-blocking sharing of computing resources and memory resources. The non-transitory storage system includes a plurality of computing nodes in the computing resource pool, an adapter board, and a plurality of solid-state drives. Communication connection between the plurality of computing nodes and the solid-state drives may be established through the adapter board, thereby expanding the storage resource pool. Through the foregoing design, the storage resource pool is expanded based on the third-generation converged architecture system and a bus interconnection technology, to achieve remote expansion of storage. In addition, the plurality of computing nodes share decoupled storage resources, thereby solving the problems that a storage capacity of conventional Just a Bunch of Flash (JBOF) may only be expanded to a limited extent and remote decoupled access to storage resources by a plurality of hosts is not capable to be achieved.

### BRIEF DESCRIPTION OF THE DRAWINGS

FIG. 1 is a system architecture diagram of a storage device in the related art;

FIG. 2 is a schematic diagram of a development process of a converged architecture;

FIG. 3 is a schematic design diagram of a third-generation converged architecture;

FIG. 4 is a structural block diagram of a converged architecture system according to an embodiment of the present application;

FIG. 5 is a system architecture diagram of a converged architecture system according to an embodiment of the present application;

FIG. 6 is a structural block diagram of a non-transitory storage system according to an embodiment of the present application;

FIG. 7 is a system architecture diagram of a non-transitory storage system according to an embodiment of the present application;

FIG. 8 is a structural block diagram of another non-transitory storage system according to an embodiment of the present application;

FIG. 9 is a principle diagram of an expansion technology of a non-transitory storage system according to an embodiment of the present application;

FIG. 10 is a schematic diagram of a connection structure of a non-transitory storage system according to an embodiment of the present application;

FIG. 11 is a schematic design diagram of a non-transitory storage system according to an embodiment of the present application;

FIG. 12 is a schematic design diagram of internal cables of a non-transitory storage system according to an embodiment of the present application;

FIG. 13 is a flow chart of steps of a method for acquiring a storage resource according to an embodiment of the present application;

FIG. 14 is a structural block diagram of an apparatus for acquiring a storage resource according to an embodiment of the present application;

FIG. 15 is a structural block diagram of an electronic device according to an embodiment of the present application; and

FIG. 16 is a structural block diagram of a non-transitory computer-readable storage medium according to an embodiment of the present application.

### DETAILED DESCRIPTION

In order to make the above objectives, features, and advantages of the present application more obvious and understandable, the following will provide further detailed explanations of the present application in conjunction with the accompanying drawings and specific embodiments. Obviously, the described embodiments are only a part of the embodiments of the present application, not all of them. Based on the embodiments described in the present application, all other embodiments obtained by those skilled in the art are within the scope of protection of the present application.

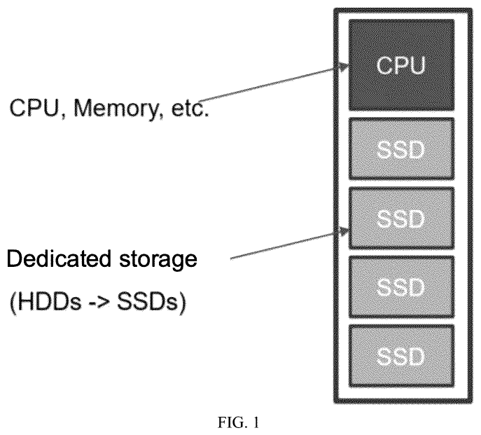

FIG. 1 is a system architecture diagram of a storage device in the related art. The storage device includes a central processing unit (CPU) and a plurality of drives of dedicated storage. The drive is classified into a hard disk drive (HDD) and a solid-state drive (also referred to as a solid state disk, SSD). The drive herein is the solid-state drive. The storage device adopts a Just a Bunch of Flash (JBOF, a storage device that has a plurality of flash-based SSDs installed in one chassis) system architecture. Compared to a storage server, JBOF, as a storage device having a flash-based SSD, has the characteristics of low costs and flexible deployment.

However, a storage capacity of the storage device with the JBOF architecture is relatively fixed and may only be expanded to a limited extent, and remote decoupled access to storage resources by a plurality of hosts is not capable to be achieved, leading to uneven utilization of storage resources of servers and an inability to balance load.

To solve the foregoing problems, the present application is intended to provide a method for configuring a storage resource pool to overcome the foregoing problems or at least solve some of the foregoing problems. Based on the third-generation converged architecture and the Peripheral Component Interconnect Express Gen 5 (PCIE Gen5) bus technology, a converged architecture system, a non-transitory storage system, a method for acquiring a storage resource, an apparatus for acquiring a storage resource, an electronic device, and a non-transitory computer-readable storage medium are proposed, to implement remote expansion of storage and multi-host sharing of decoupled storage.

The related art or related concepts are described below.

Non-Volatile Memory Express (NVME, a non-transitory memory host controller interface specification) is a host controller interface and storage protocol, and is a bus configured to accelerate data transmission between enterprise and client systems and SSDs through a PCIE (a high-speed serial computer expansion bus standard) of a computer.

It is officially defined as “a collection of open standards and information, which fully unleashes benefits of non-transitory storage in all types of computing environments, from mobile devices to data centers. NVME is designed from the ground up to provide high-bandwidth and low-latency storage access for current and future NVM technologies”. As an interface specification for connecting storage to servers via a PCIE bus, NVME essentially enables faster communication between SSDs and host systems. It helps alleviate bottlenecks that occur when a flash memory is connected to a system through Serial Attached Small Computer System Interface (SAS) or Serial Advanced Technology Attachment (SATA), which are originally designed for HDDs.

Under the trend of cloud computing, big data, and mobile Internet, cloud data centers are increasingly moving toward converged architectures. Within the strategic framework of the converged architecture, the core changes come from the decoupling and reconstruction of hardware resources such as a CPU, a memory, and input/output (I/O), which enables the full virtualization and automation of computing, storage, networks, and security resources of a data center. Furthermore, software definition technologies enable business-aware on-demand resource integration and configuration, achieving elastic scaling and ultra-large-scale continuous expansion of the system. This ultimately allows the data center to operate and be managed as a single computer entity.

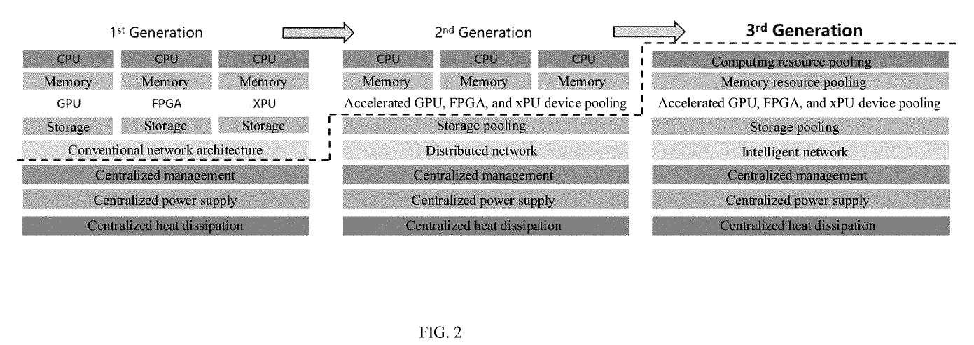

FIG. 2 is a schematic diagram of a development process of a converged architecture. The converged architecture has evolved from the first generation with simple integrated management, centralized power supply, and centralized heat dissipation, to the second generation with storage pooling and a distributed network, to the third generation with computing resource pooling, memory resource pooling, and accelerated graphics processing unit (GPU), field-programmable gate array (FPGA), and XPU (a converged processor) device pooling, which is latest generation of converged architecture.

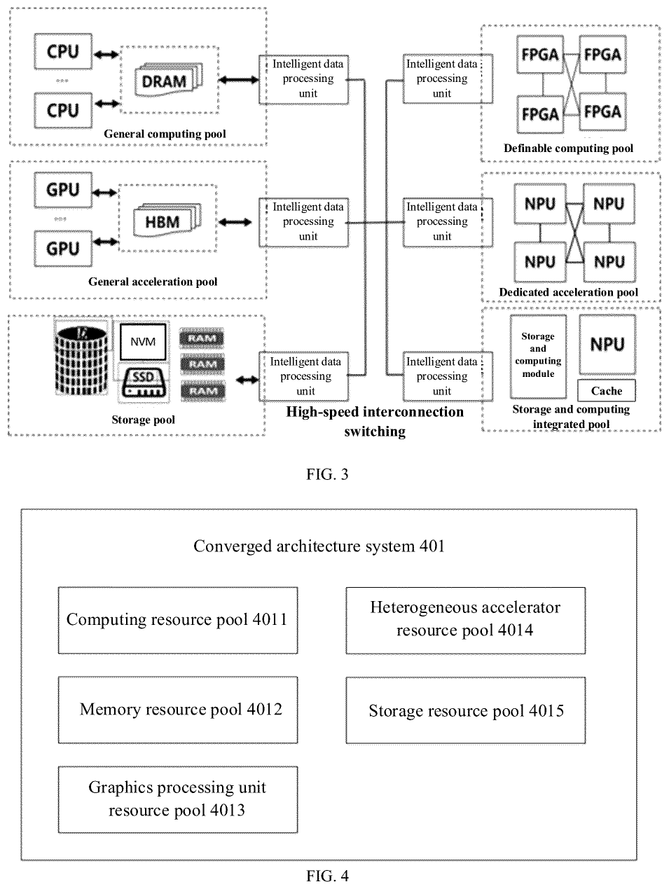

FIG. 3 is a schematic design diagram of a third-generation converged architecture. A data center is like a computer, and software may achieve a truly business-driven data center. A general computing pool integrates a CPU and a dynamic random-access memory (DRAM). A definable computing pool integrates a plurality of FPGAs. A general acceleration pool integrates a GPU and High Bandwidth Memory (HBM). A dedicated acceleration pool integrates a neural processing unit (NPU). In addition, a storage pool and a storage and computing integrated pool are included. The resource pools are interconnected and exchanged at high speed based on an intelligent data processing unit. At the hardware level, full pooling of computing, I/O, and storage is achieved; and at the software level, comprehensive management and allocation of resources are achieved, enabling users to drive applications with business and perform unified resource scheduling. Therefore, the converged architecture system may be a computer system, that integrates the above-mentioned components such as CPU, DRAM, FPGA, GPU, HBM, and NPU into this system, and manages and allocates them through a unified management platform to simplify data center management.

Benefiting from the increase in PCIE bus speed, at present, the PCIE 5.0 protocol has broad prospects for industrial application. PCIE 4.0 will be quickly transitioned, and PCIE 6.0 products will not be available for at least three years, and thus, a PCIE 5.0 CPU will remain for a long time. An I/O Fabric system network developed based on PCIE 5.0 SW may achieve dynamic allocation of PCIE channels within a resource pool system for different application requirements, with high bandwidth, low latency, and maximized PCIE resource utilization. Compute Express Link (CXL, a cache coherent interconnect protocol) is a new protocol developed based on PCIE 5.0, running on a PCIE physical layer, with the same electrical characteristics, and optimized for cache and memory. CXL is an open industrial standard for high-bandwidth and low-latency device interconnection. On basis of PCIE 5.0, CXL reuses three types of protocols, namely, CXL.io, CXL.cache, and CXL.memory. CXL.io is used for discovery, configuration, register access, interrupts, and the like. CXL.cache is used to cache memory from a processor when a device accesses the memory of the processor. CXL.memory is used to process accesses from a processor to an internal memory of a device. CXL maintains a consistent memory space between the CPU and the device.

Under such a background, based on the third-generation converged architecture and the PCIE 5.0 bus technology, a converged architecture system, a non-transitory storage system, a method for acquiring a storage resource, an apparatus for acquiring a storage resource, an electronic device, and a non-transitory computer-readable storage medium are proposed, to implement remote expansion of storage and multi-host sharing of decoupled storage.

One of the core concepts of the embodiments of the present application is to provide a converged architecture system and a non-transitory storage system constructed based on the converged architecture system. The converged architecture system includes a computing resource pool, a memory resource pool, a graphics processing unit resource pool, a heterogeneous accelerator resource pool, and a storage resource pool constructed based on a solid-state drive. The computing resource pool is connected to the memory resource pool over a first switching network for communication. The computing resource pool, the graphics processing unit resource pool, the storage resource pool, and the heterogeneous accelerator resource pool are connected to each other over a second switching network for communication. Through the foregoing design, large-scale resource pool decoupling may be achieved, and multi-host sharing and dynamic allocation of resources may also be achieved. The resource pool may be allocated to a plurality of users as needed, and meanwhile, the resources may be easily expanded to increase the capacity of the resource pool. Further, the computing resource pool is connected to the memory resource pool over the first switching network for communication, thereby achieving memory resource pooling and multi-host non-blocking sharing of computing resources and memory resources. The non-transitory storage system includes a plurality of computing nodes in the computing resource pool, an adapter board, and a plurality of solid-state drives. Communication connection between the plurality of computing nodes and the solid-state drives may be established through the adapter board, thereby expanding the storage resource pool. Through the foregoing design, the storage resource pool is expanded based on the third-generation converged architecture system and the bus interconnection technology, to achieve remote expansion of storage. In addition, the plurality of computing nodes share decoupled storage resources, thereby solving the problems that a storage capacity of conventional JBOF may only be expanded to a limited extent and remote decoupled access to storage resources by a plurality of hosts is not capable to be achieved.

FIG. 4 is a structural block diagram of a converged architecture system according to an embodiment of the present application. A converged architecture system 401 includes a computing resource pool 4011, a memory resource pool 4012, a graphics processing unit resource pool 4013, a heterogeneous accelerator resource pool 4014, and a storage resource pool 4015 constructed based on a solid-state drive.

The computing resource pool 4011 is connected to the memory resource pool 4012 over a first switching network for communication.

The computing resource pool 4011, the graphics processing unit resource pool 4013, the storage resource pool 4015, and the heterogeneous accelerator resource pool 4014 are connected to each other over a second switching network for communication.

In some embodiments of the present application, the computing resource pool, the graphics processing unit resource pool, the storage resource pool, and the heterogeneous accelerator resource pool are connected to each other over the second switching network for communication in the following ways:
the computing resource pool is connected to the second switching network via a first bus, and is connected to the graphics processing unit resource pool, the storage resource pool, and the heterogeneous accelerator resource pool via the second switching network;
the graphics processing unit resource is connected to the second switching network via a second bus, and is connected to the computing resource pool, the storage resource pool, and the heterogeneous accelerator resource pool via the second switching network;
the storage resource pool is connected to the second switching network via a third bus, and is connected to the computing resource pool, the graphics processing unit resource pool, and the heterogeneous accelerator resource pool via the second switching network; and
the heterogeneous accelerator resource pool is connected to the second switching network via a fourth bus, and is connected to the computing resource pool, the graphics processing unit resource pool, and the storage resource pool via the second switching network.

In some embodiments of the present application, the first switching network is a CXL Fabric switching network, the second switching network is a PCIE I/O Fabric switching network, the storage resource pool is an NVME SSD storage resource pool, and the first bus and/or the second bus and/or the third bus and/or the fourth bus are PCIE GEN5 buses.

A Fabric switching network transmits data to its destination through a mesh structure of connections between access points, switches, and routers. The Fabric architecture is essentially a 2*4 CLOS topology architecture. CLOS is a multi-level circuit switching network structure. The CLOS topology may provide a non-blocking network. The Fabric topology includes two layers of switches. The topology structure may achieve full interconnection between layers internally and support 40 slots externally. In addition to the 2*4 CLOS topology, it supports 2*2 and 2*1 topology adjustments, and all slots support uplink and downlink multiplexing. Therefore, the Fabric switching network in the present application may include a plurality of interconnected switches, and these switches may be provided with PCIE interfaces or CXL interfaces to respectively constitute the PCIE I/O Fabric switching network or the CXL Fabric switching network. Connection via the PCIE bus and the PCIE interface or CXL interface may achieve the interconnection between different resource pools.

PCIE is a universal bus specification that may be applied to a bus transmission interface inside a computer system. The PCIE GEN5 bus, also known as PCLE 5.0 bus, is a tree-shaped interface bus. In the present application, all the first bus, the second bus, the third bus, and the fourth bus that achieve the interconnection of the resource pools may be PCIE GEN5 buses.

The storage resource pool constructed based on the solid-state drive of the present application may be the NVME SSD storage resource pool.

In some embodiments of the present application, the computing resource pool includes a near-end memory, and the memory resource pool includes a remote memory.

In some embodiments of the present application, the first switching network includes a plurality of first switching chips, and any two first switching chips of two layers are interconnected; and/or the second switching network includes a plurality of second switching chips, any two second switching chips of the two layers are interconnected, and CPUs in the computing resource pool are interconnected via a fast channel interconnection bus.

The switching network includes a plurality of switches, and each switch has a corresponding switching chip. Each first switching chip in the first switching network may be a CXL switching chip, and each second switching chip in the second switching network may be a PCIE switching chip, and any two switching chips of two layers of switches in the switching network are interconnected.

The CPUs in the computing resource pool are interconnected via the fast channel interconnection bus, namely, an Intel Ultra Path Interconnect (UPI) bus. Each CPU has a correspondingly connected near-end memory. Expansion of computing nodes and cache consistency between the computing nodes of the CPUs may be achieved through the UPI bus, and computing resource pooling is achieved through the CPU Fabric interconnection network.

The CPU Fabric may be a Fabric topology including a plurality of switches. The UPI bus is configured to achieve direct interconnection between CPU chips. Expansion between the nodes that is achieved through the UPI bus may ensure higher communication rate and efficiency and lower power consumption between the computing nodes.

In some embodiments of the present application, the remote memory of the memory resource pool is expanded over the first switching network.

In some embodiments of the present application, a network offload acceleration chip is connected to the converged architecture system over the second switching network for communication.

The network offload acceleration chip may be a data processing unit (DPU)/an intelligent processing unit (IPU) chip.

In some embodiments of the present application, the network offload acceleration chip is connected to the converged architecture system over the second switching network for communication in the following ways:

the network offload acceleration chip is connected to the second switching network via a fifth bus, and is connected to the computing resource pool, the memory resource pool, the graphics processing unit resource pool, the heterogeneous accelerator resource pool, and the storage resource pool via the second switching network.

The fifth bus may be a PCIE GEN 5 bus.

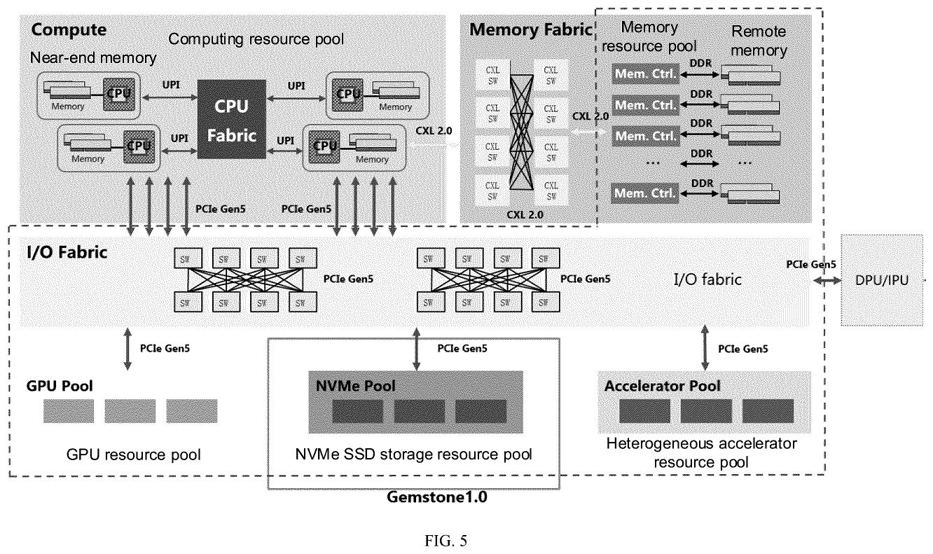

The converged architecture system provided in the embodiments of the present application is constructed based on the third-generation converged architecture. FIG. 5 is a system architecture diagram of a converged architecture system according to an embodiment of the present application. The converged architecture system includes a computing resource pool, a memory resource pool, a graphics processing unit resource pool (GPU resource pool), a heterogeneous accelerator resource pool, and an NVME SSD storage resource pool, which achieves large-scale host and I/O expansion decoupling through a PCIE I/O Fabric switching network, and achieves I/O resource pooling, multi-host sharing of resources and dynamic allocation of multi-host shared resources, a high-concurrency NVME SSD storage resource pool, and a multi-host shared GPU resource pool.

The converged architecture system provided in the embodiments of the present application achieves full pooling of all information technology resources such as a CPU and a memory, and may achieve any combination at the hardware level. It intelligently allocates and integrates resources according to application requirements, and achieve a fully business-driven software-defined data center. That is, at the hardware level, the entire data center is regarded as a computer, and at the software level, business drive and application perception are achieved.

In conclusion, in the embodiments of the present application, the converged architecture system includes the computing resource pool, the memory resource pool, the graphics processing unit resource pool, the heterogeneous accelerator resource pool, and the storage resource pool constructed based on the solid-state drive. The computing resource pool is connected to the memory resource pool over the first switching network for communication. The computing resource pool, the graphics processing unit resource pool, the storage resource pool, and the heterogeneous accelerator resource pool are connected to each other over the second switching network for communication. Through the foregoing design, large-scale resource pool decoupling may be achieved, and multi-host sharing and dynamic allocation of resources may also be achieved. The resource pool may be allocated to a plurality of users as needed, and meanwhile, resources may be easily expanded to increase the capacity of the resource pool. Further, the computing resource pool is connected to the memory resource pool over the first switching network, thereby achieving memory resource pooling and multi-host non-blocking sharing of computing resources and memory resources.

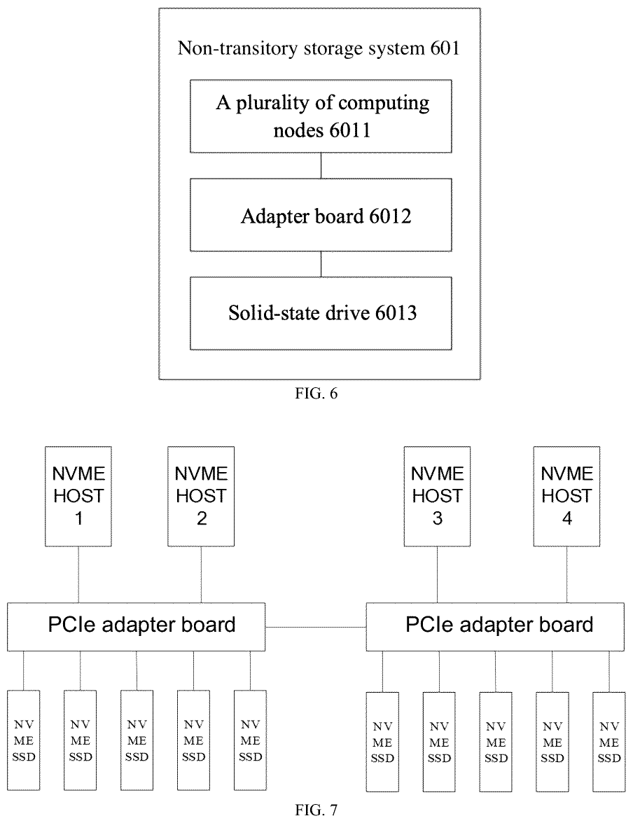

FIG. 6 is a structural block diagram of a non-transitory storage system according to an embodiment of the present application. The non-transitory storage system is constructed based on the foregoing converged architecture system. The non-transitory storage system 601 includes:
a plurality of computing nodes 6011 in the computing resource pool, an adapter board 6012, and a plurality of solid-state drives 6013.

The solid-state drives 6013 are configured to establish a communication connection with the plurality of computing nodes 4011 through the adapter board 6012 to expand the storage resource pool.

The non-transitory storage system includes the plurality of computing nodes in the computing resource pool, the adapter board, and the plurality of solid-state drives. The adapter board may be a PCIE adapter board, and the solid-state drives are solid-state drives based on the NVME protocol.

In the non-transitory storage system provided in the embodiments of the present application, the communication connection between the plurality computing nodes in the computing resource pool and the plurality of solid-state drives based on the NVME protocol may be established through the PCIE adapter board.

FIG. 7 is a system architecture diagram of a non-transitory storage system according to an embodiment of the present application. In the system architecture, four computing nodes (NVME hosts) are connected to ten solid-state drives (NVME SSDs) through a PCIE adapter board.

In conclusion, in the embodiments of the present application, the non-transitory storage system includes the plurality of computing nodes in the computing resource pool, the adapter board, and the plurality of solid-state drives. The communication connection between the solid-state drives and the plurality of computing nodes may be established through the adapter board, thereby expanding the storage resource pool. Through the foregoing design, the storage resource pool is expanded based on the third-generation converged architecture system and the PCIE bus technology, to achieve remote expansion of storage. In addition, the plurality of computing nodes share decoupled storage resources, thereby solving the problems that a storage capacity of conventional JBOF may only be expanded to a limited extent and remote decoupled access to storage resources by a plurality of hosts is not capable to be achieved.

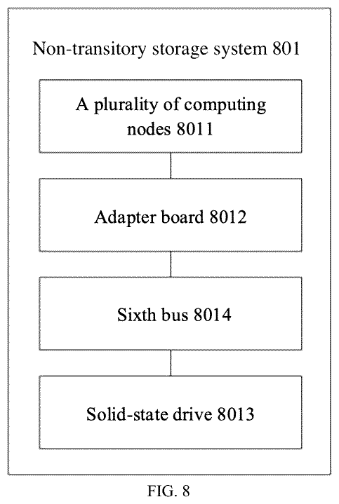

FIG. 8 is a structural block diagram of another non-transitory storage system according to an embodiment of the present application. The non-transitory storage system is constructed based on the foregoing converged architecture system. The non-transitory storage system 801 includes:

a plurality of computing nodes 8011 in the computing resource pool, an adapter board 8012, and a plurality of solid-state drives 8013.

The solid-state drives 8013 are configured to establish a communication connection with the plurality of computing nodes 8011 through the adapter board 8012 to expand the storage resource pool.

The non-transitory storage system further includes:
a sixth bus 8014.

The sixth bus 8014 is configured to establish a physical link between the solid-state drives 8013 and the adapter board 8012.

A quantity of data lanes in the physical link is determined based on a quantity of solid-state drives that need to be supported.

In the embodiments of the present application, the non-transitory storage system includes the plurality of computing nodes in the computing resource pool, the adapter board, and the plurality of solid-state drives based on the NVME protocol, and a PCIE bus, namely, the sixth bus.

In the non-transitory storage system provided in the embodiments of the present application, the communication connection between the plurality of computing nodes in the computing resource pool and the plurality solid-state drives based on the NVME protocol may be established through a PCIE adapter board, and the physical link between the solid-state drives and the adapter board may be established through the sixth bus.

The quantity of data lanes in the physical link between the solid-state drives and the adapter board is positively correlated with the quantity of solid-state drives supported.

In a specific implementation, a large number of data lanes are required for supporting a large number of solid-state drives. For example, 128 PCIE lanes are required for supporting 32 solid-state drives.

In some embodiments of the present application, the second switching network is a two-layer CLOS topology architecture, and the computing node is a CPU node.

The CPU node is configured to transmit a PCIE signal to another CPU node over the second switching network, to achieve full interconnection and non-blocking transmission of PCIE resources of CPU nodes.

In some embodiments of the present application, the plurality of computing nodes belong to a plurality of computing platforms, respectively.

The CPU node belonging to a first computing platform is configured to transmit the PCIE signal to the CPU node belonging to a second computing platform over the second switching network.

The plurality of computing nodes provided in the embodiments of the present application may be computing nodes of the plurality of computing platforms, such as CPU nodes based on Intel, AMD, Ampere, or another platform. Full interconnection and non-blocking transmission of PCIE resources of CPUs of various platforms are achieved through a 2*4 two-tier CLOS topology architecture (two layer, each layer including 4 switches). The CLOS topology architecture was first formalized by Charles Clos from Bell Labs in 1952. The CLOS topology architecture is strictly non-blocking, reconfigurable (re-arrangeable), and scalable. Compared with the conventional CrossBar architecture, it has a huge improvement in burst traffic processing, congestion avoidance, and recursive expansion.

The plurality of computing nodes provided in the embodiments of the present application may be configured to provide PCIE GEN5 slots, such as PCIE GEN5 x16 slots. All slots support uplink multiplexing, downlink multiplexing, network topology structure adjustment, multi-computing node I/O resource sharing, and device hot plugging.

All slots of the CPU node provided in the embodiments of the present application support uplink & downlink multiplexing, support 2*4, 2*2, 2*1 topology adjustment, support multi-host (a multi-lane technology, in which a host may be based on different CPU architectures) I/O resource sharing, support device hot plugging, and achieve real-time topology management and status monitoring as well as dynamic allocation of PCIE resources.

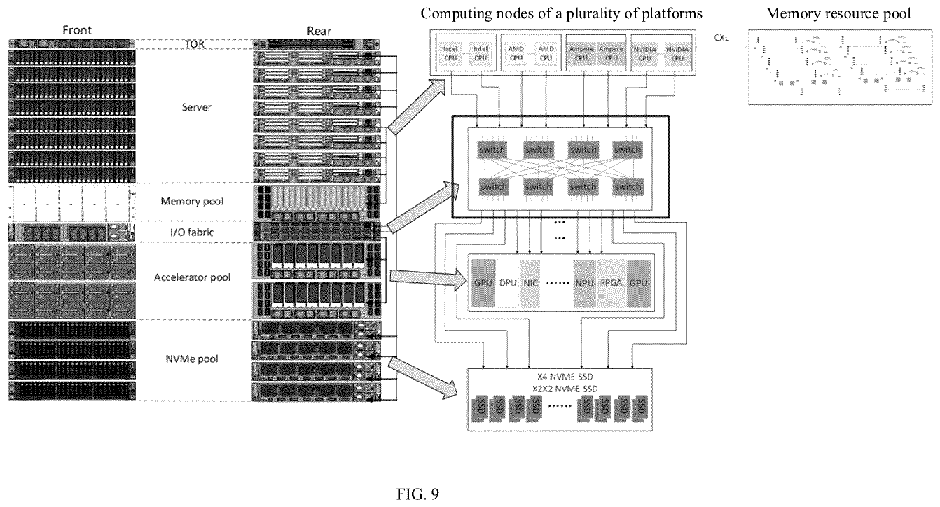

FIG. 9 is a principle diagram of an expansion technology of a non-transitory storage system according to an embodiment of the present application. The expansion technology involves the resource pools mentioned above, and computing nodes of a plurality of platforms in the computing resource pool may access the storage resource pool.

In some embodiments of the present application, the non-transitory storage system 801 further includes:
a first cable.

The first cable is configured to transmit the PCIE signal transmitted via the sixth bus to the storage resource pool.

The first cable is a CDFP cable. The CDFP standard was formalized earlier, and so far, the third edition of the specification has been released. It uses 16 channels with a single channel rate of 25 G. Due to the large number of channels, the size is relatively large. CDFP 2.0 may reach a data rate of 25 Gbps on each of the 16 channels, thereby achieving a total data transmission speed of 400 Gbps. In the embodiments of the present application, the NVME SSD storage resource pool is connected and expanded through the CDFP cable.

In the non-transitory storage system provided in the embodiments of the present application, the PCIE signal of the PCIE bus is transmitted to the NVME SSD storage resource pool through the CDFP cable supporting a PCIE technology. The CDFP cable may support the fifth-generation PCIE technology.

In some embodiments of the present application, the non-transitory storage system 801 further includes:
a signal conditioning component.

The signal conditioning component is configured to re-construct the PCIE signal transmitted via the first cable based on an internal clock to increase transmission energy of the PCIE signal.

In the non-transitory storage system provided in the embodiments of the present application, to solve the signal transmission loss problem caused by the first cable, the signal conditioning component is configured to reconstruct the signal based on the internal clock when the PCIE signal passes through the signal conditioning component, to increase the signal transmission energy, and then the signal is transmitted. The signal conditioning component may be a Retimer device having Clock Data Recovery (CDR) therein. After data is recovered, the signal is transmitted via a serial channel, which may reduce the jitter of the signal.

In some embodiments of the present application, the signal conditioning component is deployed with a signal enhancement chip.

The signal enhancement chip is configured to split the PCIE signal into a plurality of combinations of signal channels.

PCIE is a high-speed serial computer expansion bus standard. PCIE belongs to high-speed serial point-to-point dual-channel high-bandwidth transmission. Connected devices are allocated with exclusive channel bandwidth and do not share bus bandwidth. It mainly supports functions such as active power management, error reporting, end-to-end reliability transmission, hot plugging, and service quality. In the field of computers, the PCIE signal is the most important high-speed signal outputted by the CPU. Generally, a PCIE controller has a plurality of signal channels, among which 16 channels (represented by x16 in the following) are more common. One x16 may be split into a plurality of combinations of signal channels such as two x8 (represented by x8x8 in the following), x8x4x4, x4x8x4, x4x4x8, or x4x4x4x4.

Different external PCIE devices (such as network cards or NVME solid-state drives) require different quantities of PCIE channels. For example, one 10 g network card requires 8 channels; and one NVME solid-state drive requires 4 channels. Therefore, for different PCIE devices connected, the quantity of channels that need to be split for PCIE is also different. If the quantity of channels split for PCIE is not matched with the external PCIE device, the external PCIE device will not be able to operate normally or the PCIE signal channel resources will be wasted.

The signal enhancement chip may adopt a PT5161 chip to overcome the performance bottleneck of a data-centric application system. The signal enhancement chip may achieve a low-latency PCIE 5.0 connection solution, and support splitting of the plurality of combinations of signal channels, such as x8x8, x8x4x4, x4x8x4, x4x4x8, or x4x4x4x4.

In some embodiments of the present application, the non-transitory storage system 801 further includes:
a second cable.

The second cable is configured to acquire a re-constructed PCIE signal and transmit the re-constructed PCIE signal to a drive backplane of the solid-state drive.

The second cable may be a Mini Cool Edge IO (MCIO) cable. Mini Cool Edge IO is a flexible, sturdy, and cost-effective connector that may help product designers improve flexibility, reduce overall space requirements, and expand the coverage of high-speed signals.

In the non-transitory storage system provided in the embodiments of the present application, the PCIE signal reconstructed by the signal conditioning component is connected to the drive backplane through the MCIO cable, and finally the drive backplane is interconnected.

FIG. 10 is a schematic diagram of a connection structure of a non-transitory storage system according to an embodiment of the present application. The PCIE signal outputted by the computing node is transmitted to the signal conditioning component via the PCIE bus, transmitted to the second cable by the signal conditioning component, and transmitted to the drive backplane of the solid-state drive via the second cable.

In some embodiments of the present application, the storage resource pool includes any one or combination of the following:

an NVME SSD storage resource pool based on a U.2 form factor and an NVME SSD storage resource pool based on an E3.S form factor.

As an example, the non-transitory storage system 801 may include 12 Retimer devices, 24 SAS/SATA solid-state drives, 24 U.2 NVME solid-state drives, and 24 E3.S NVME solid-state drives; the physical link between the solid-state drive and the adapter board includes 192 pairs of data lanes.

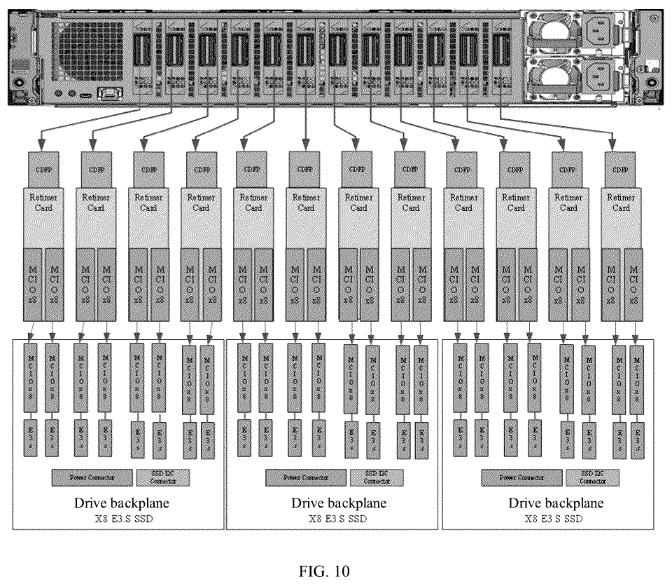

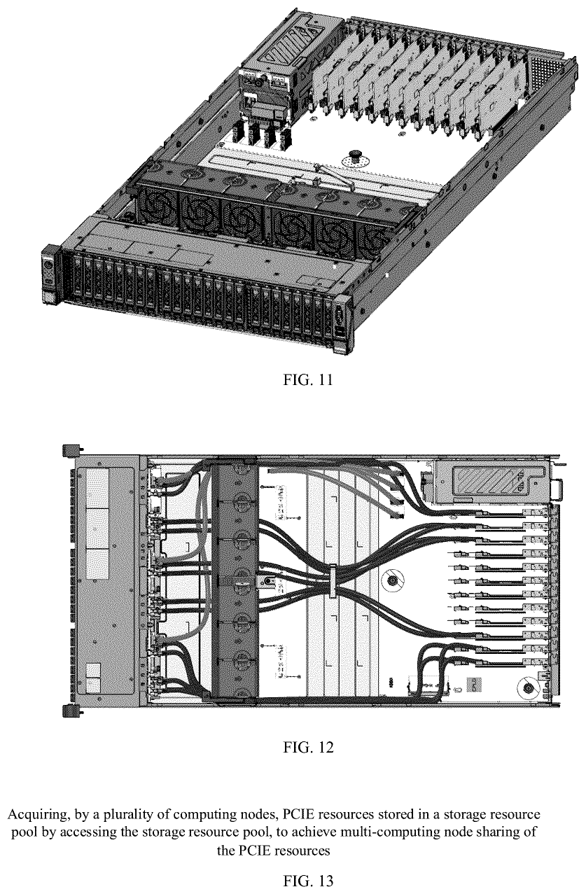

FIG. 11 is a schematic design diagram of a non-transitory storage system according to an embodiment of the present application. FIG. 12 is a schematic design diagram of internal cables of a non-transitory storage system according to an embodiment of the present application. 12 signal conditioning components are placed in a chassis, which may provide 192 pairs of PCIE 5.0 data lanes for drive expansion, support 24 SAS/SATA solid-state drives, 24 U.2 NVME solid-state drives, and 24 E3.S NVME solid-state drives (x4 x8).

In some embodiments of the present application, the adapter board is deployed with a PCIE switching chip.

The PCIE switching chip is configured to implement PCIE link switching.

In conclusion, in the embodiments of the present application, the non-transitory storage system includes the plurality of computing nodes in the computing resource pool, the adapter board, and the plurality of solid-state drives based on the NVME protocol. The communication connection between the solid-state drives and the plurality of computing nodes may be established through the adapter board, thereby expanding the storage resource pool.

Through the foregoing design, the storage resource pool is expanded based on the third-generation converged architecture system and the PCIE bus technology, to achieve remote expansion of storage. In addition, the plurality of computing nodes share decoupled storage resources, thereby solving the problems that a storage capacity of conventional JBOF may only be expanded to a limited extent and remote decoupled access to storage resources by a plurality of hosts is not capable to be achieved.

FIG. 13 is a flow chart of steps of a method for acquiring a storage resource according to an embodiment of the present application, which is applied to the foregoing non-transitory storage system and may include the following steps:

Step 1301: Acquiring, by the plurality of computing nodes, PCIE resources stored in the storage resource pool by accessing the storage resource pool, to achieve multi-computing node sharing of the PCIE resources.

In the embodiments of the present application, the plurality of computing nodes acquire the PCIE resources stored in the storage resource pool by accessing the storage resource pool, to achieve multi-computing node sharing of the PCIE resources.

In some embodiments of the present application, the method may further include the following steps:

automatically adjusting, by the storage resource pool, load of the storage resource pool in real time during operation of the system, to achieve load balancing of the storage resource pool.

In the embodiments of the present application, during the operation of the system, the storage resource pool may automatically adjust its own load in real time, to achieve load balancing of the storage resource pool.

In some embodiments of the present application, the method may further include the following steps:

monitoring resource requirements of the plurality of computing nodes for PCIE resources in real time.

In the embodiments of the present application, the resource requirements of the plurality of computing nodes for PCIE resources may be monitored in real time.

In conclusion, in the embodiments of the present application, the non-transitory storage system includes the plurality of computing nodes in the computing resource pool, the adapter board, and the plurality of solid-state drives based on the NVME protocol. The communication connection between the solid-state drives and the plurality of computing nodes may be established through the adapter board, thereby expanding the storage resource pool.

Through the foregoing design, the storage resource pool is expanded based on the third-generation converged architecture system and the PCIE bus technology, to achieve remote expansion of storage. In addition, the plurality of computing nodes share decoupled storage resources, thereby solving the problems that a storage capacity of conventional JBOF may only be expanded to a limited extent and remote decoupled access to storage resources by a plurality of hosts is not capable to be achieved. Meanwhile, utilization of storage resources is improved and load balancing is achieved.

It should be noted that, for ease of description, the method embodiments are expressed as combinations of a series of actions, but those skilled in the art should be aware that the embodiments of the present application are not limited to the described order of actions, because according to the embodiments of the present application, certain steps may be performed in other orders or simultaneously. In addition, those skilled in the art should also be aware that the embodiments described in the description are some embodiments, and the actions involved are not necessarily required by the embodiments of the present application.

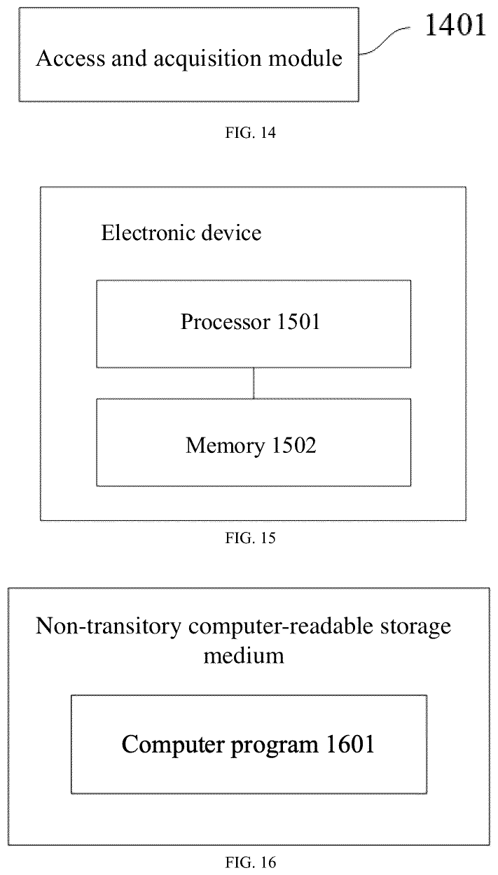

FIG. 14 is a structural block diagram of an apparatus for acquiring a storage resource according to an embodiment of the present application, which is applied to the foregoing non-transitory storage system and may include the following modules:
an access and acquisition module 1401, configured to acquire PCIE resources stored in the storage resource pool by accessing the storage resource pool, to achieve multi-computing node sharing of the PCIE resources.

In some embodiments of the present application, the apparatus further includes:
a load balancing module, configured to control the storage resource pool to automatically adjust its own load in real time during operation of the system, to achieve load balancing of the storage resource pool.

In some embodiments of the present application, the apparatus further includes:
a monitoring module, configured to monitor resource requirements of the plurality of computing nodes for PCIE resources in real time.

In conclusion, in the embodiments of the present application, the non-transitory storage system includes the plurality of computing nodes in the computing resource pool, the adapter board, and the plurality of solid-state drives based on the NVME protocol. The communication connection between the solid-state drives and the plurality of computing nodes may be established through the adapter board, thereby expanding the storage resource pool. Through the foregoing design, the storage resource pool is expanded based on the third-generation converged architecture system and the PCIE bus technology, to achieve remote expansion of storage. In addition, the plurality of computing nodes share decoupled storage resources, thereby solving the problems that a storage capacity of conventional JBOF may only be expanded to a limited extent and remote decoupled access to storage resources by a plurality of hosts is not capable to be achieved. Meanwhile, utilization of storage resources is improved and load balancing is achieved.

Because the apparatus embodiments are basically similar to the method embodiments, the description is relatively simple. For the relevant parts, refer to the partial description of the method embodiments.

The embodiments of the present application further provide an electronic device, as shown in FIG. 15, which includes: a processor 1501, a memory 1502, and a computer program stored in the memory and capable of running on the processor. The processor executes the computer program to implement each process of the foregoing method for acquiring a storage resource provided in the embodiments, and the same technical effect may be achieved, for example:
controlling the plurality of computing nodes to acquire PCIE resources stored in the storage resource pool by accessing the storage resource pool, to achieve multi-computing node sharing of the PCIE resources.

In some embodiments, the method further includes:
controlling the storage resource pool to automatically adjust load of the storage resource pool in real time during operation of the system, to achieve load balancing of the storage resource pool.

In some embodiments, the method further includes:
monitoring resource requirements of the plurality of computing nodes for PCIE resources in real time.

In conclusion, in the embodiments of the present application, the non-transitory storage system includes the plurality of computing nodes in the computing resource pool, the adapter board, and the plurality of solid-state drives based on the NVME protocol. The communication connection between the solid-state drives and the plurality of computing nodes may be established through the adapter board, thereby expanding the storage resource pool. Through the foregoing design, the storage resource pool is expanded based on the third-generation converged architecture system and the PCIE bus technology, to achieve remote expansion of storage. In addition, the plurality of computing nodes share decoupled storage resources, thereby solving the problems that a storage capacity of conventional JBOF may only be expanded to a limited extent and remote decoupled access to storage resources by a plurality of hosts is not capable to be achieved. Meanwhile, utilization of storage resources is improved and load balancing is achieved.

The embodiments of the present application further provide a non-transitory computer-readable storage medium, as shown in FIG. 16, which has a computer program 1601 stored therein. A processor executes the computer program to implement each process of the foregoing method for acquiring a storage resource provided in the embodiments, and the same technical effect may be achieved, for example:
controlling the plurality of computing nodes to acquire PCIE resources stored in the storage resource pool by accessing the storage resource pool, to achieve multi-computing node sharing of the PCIE resources.

In some embodiments, the method further includes:
controlling the storage resource pool to automatically adjust load of the storage resource pool in real time during operation of the system, to achieve load balancing of the storage resource pool.

In some embodiments, the method further includes:
monitoring resource requirements of the plurality of computing nodes for PCIE resources in real time.

In conclusion, in the embodiments of the present application, the non-transitory storage system includes the plurality of computing nodes in the computing resource pool, the adapter board, and the plurality of solid-state drives based on the NVME protocol. The communication connection between the solid-state drives and the plurality of computing nodes may be established through the adapter board, thereby expanding the storage resource pool. Through the foregoing design, the storage resource pool is expanded based on the third-generation converged architecture system and the PCIE bus technology, to achieve remote expansion of storage. In addition, the plurality of computing nodes share decoupled storage resources, thereby solving the problems that a storage capacity of conventional JBOF may only be expanded to a limited extent and remote decoupled access to storage resources by a plurality of hosts is not capable to be achieved. Meanwhile, utilization of storage resources is improved and load balancing is achieved.

The various embodiments in this specification are described in a progressive manner, with each embodiment emphasizing its differences from other embodiments. The same and similar parts between the various embodiments may be referred to each other.

Persons skilled in the art should understand that the embodiments of the present application may be provided as methods, devices, or computer program products. Therefore, the embodiments of the present application may take the form of fully hardware embodiments, fully software embodiments, or embodiments combining software and hardware aspects. Moreover, the embodiments of the present application may take the form of a computer program product implemented on one or more computer usable storage media (including but not limited to disk storage, CD-ROM, optical storage, etc.) containing computer usable program code.

The embodiments of the present application are described with reference to the flow chart and/or block diagram of the method, terminal device (system), and computer program product according to the embodiments of this application. It should be understood that each process and/or block in the flow chart and/or block diagram, as well as the combination of processes and/or blocks in the flow chart and/or block diagram, may be implemented by computer program instructions. These computer program instructions may be provided to a processor of a general-purpose computer, specialized computer, embedded processor, or other programmable data processing terminal device to generate a machine, such that the instructions executed by the processor of the computer or other programmable data processing terminal device generate a device for implementing the functions specified in one or more processes in the flow chart and/or one or more boxes in the block diagram.

These computer program instructions may also be stored in computer-readable memory that may guide a computer or other programmable data processing terminal device to operate in a specific manner, such that the instructions stored in the computer-readable memory generate a manufactured product including instruction devices that implement the functions specified in a flowchart or multiple flowcharts and/or a block diagram or multiple boxes.

These computer program instructions may also be loaded onto a computer or other programmable data processing terminal device, enabling a series of operational steps to be executed on the computer or other programmable terminal device to generate computer implemented processing. The instructions executed on the computer or other programmable terminal device provide steps for implementing the functions specified in one or more processes in the flow chart and/or one or more boxes in the block diagram.

Although some embodiments of the present application have been described, those skilled in the art may make additional changes and modifications to these embodiments once they have knowledge of the basic inventive concept. Therefore, the attached claims are intended to be interpreted as including the embodiments and all changes and modifications falling within the scope of the embodiments of the present application.

Finally, it should be noted that in this specification, relational terms such as first and second are only used to distinguish one entity or operation from another, and do not necessarily require or imply any actual relationship or order between these entities or operations. Moreover, the terms “including/comprising”, “containing”, or any other variation thereof are intended to encompass non-exclusive inclusion, such that a process, method, article, or terminal device that includes a series of elements not only includes those elements, but also includes other elements not explicitly listed, or also includes elements inherent to such process, method, article, or terminal device. Without further limitations, the element limited by the statement “including one . . . ” does not exclude the existence of other identical elements in the process, method, item, or terminal device that includes the element.

The converged architecture system, the non-transitory storage system, the method for acquiring a storage resource, the apparatus for acquiring a storage resource, the electronic device, and the non-transitory computer-readable storage medium provided by the present application have been described in detail above. Specific examples are used herein to illustrate the principles and implementations of the present application. The description of the foregoing embodiments is only used to help understand the method of the present application and its core idea. Meanwhile, those of ordinary skill in the art may make changes to the specific implementations and application scope according to the idea of the present application. In conclusion, the content of the description should not be understood as a limitation on the present application.

1. A converged architecture system, comprising a computing resource pool, a memory resource pool, a graphics processing unit resource pool, a heterogeneous accelerator resource pool, and a storage resource pool constructed based on a solid-state drive;
the computing resource pool is connected to the memory resource pool over a first switching network for communication, to achieve memory resource pooling and multi-host non-blocking sharing of computing resources and memory resources; and
the computing resource pool, the graphics processing unit resource pool, the storage resource pool, and the heterogeneous accelerator resource pool are connected to each other over a second switching network for communication, to achieve large-scale resource pool decoupling and multi-host sharing and dynamic allocation of resources.

2. The converged architecture system according to claim 1, wherein the computing resource pool, the graphics processing unit resource pool, the storage resource pool, and the heterogeneous accelerator resource pool are connected to each other over the second switching network for communication in following ways:
the computing resource pool is connected to the second switching network via a first bus, and is connected to the graphics processing unit resource pool, the storage resource pool, and the heterogeneous accelerator resource pool via the second switching network;
the graphics processing unit resource pool is connected to the second switching network via a second bus, and is connected to the computing resource pool, the storage resource pool, and the heterogeneous accelerator resource pool via the second switching network;
the storage resource pool is connected to the second switching network via a third bus, and is connected to the computing resource pool, the graphics processing unit resource pool, and the heterogeneous accelerator resource pool via the second switching network; and
the heterogeneous accelerator resource pool is connected to the second switching network via a fourth bus, and is connected to the computing resource pool, the graphics processing unit resource pool, and the storage resource pool via the second switching network.

3. The converged architecture system according to claim 1, wherein the computing resource pool comprises a near-end memory, and the memory resource pool comprises a remote memory.

4. The converged architecture system according to claim 1, wherein the first switching network comprises a plurality of first switching chips, and any two first switching chips of two layers are interconnected; and/or, the second switching network comprises a plurality of second switching chips, any two second switching chips of the two layers are interconnected, and central processing units in the computing resource pool are interconnected via a fast channel interconnection bus.

5. The converged architecture system according to claim 1, wherein a remote memory of the memory resource pool is expanded over the first switching network.

6. The converged architecture system according to claim 1, wherein a network offload acceleration chip is connected to the converged architecture system over the second switching network for communication.

7. The converged architecture system according to claim 6, wherein the network offload acceleration chip is connected to the converged architecture system over the second switching network for communication in following ways:
the network offload acceleration chip is connected to the second switching network via a fifth bus, and is connected to the computing resource pool, the memory resource pool, the graphics processing unit resource pool, the heterogeneous accelerator resource pool, and the storage resource pool via the second switching network.

8. The converged architecture system according to claim 2, wherein the first switching network is a Compute Express Link (CXL) Fabric switching network, the second switching network is a Peripheral Component Interconnect Express (PCIE) Input/output (I/O) Fabric switching network, the storage resource pool is a Non-Volatile Memory Express (NVME) solid-state drive (SSD) storage resource pool, and the first bus and/or the second bus and/or the third bus and/or the fourth bus are PCIE GEN5 buses.

9. The converged architecture system according to claim 1, wherein the converged architecture system may be a computer system.

10. A non-transitory storage system, constructed based on the converged architecture system according to claim 1 and comprising:
a plurality of computing nodes in the computing resource pool, an adapter board, and a plurality of solid-state drives;
wherein the plurality of solid-state drives are configured to establish a communication connection with the plurality of computing nodes through the adapter board to expand the storage resource pool.

11. The non-transitory storage system according to claim 10, further comprising:
a sixth bus;
wherein the sixth bus is configured to establish a physical link between the solid-state drives and the adapter board, and a quantity of data lanes in the physical link is determined based on a quantity of solid-state drives that need to be supported.

12. The non-transitory storage system according to claim 11, wherein the second switching network is a two-tier CLOS topology architecture;
the plurality of computing nodes are central processing unit nodes; and
each of the central processing unit nodes is configured to transmit a PCIE signal to another central processing unit node over the second switching network, to achieve full interconnection and non-blocking transmission of PCIE resources between the central processing unit nodes.

13. The non-transitory storage system according to claim 12, wherein
the plurality of computing nodes belong to a plurality of computing platforms, respectively; and
the central processing unit node belonging to a first computing platform is configured to transmit the PCIE signal to the central processing unit node belonging to a second computing platform over the second switching network.

14. The non-transitory storage system according to claim 12, further comprising:
a first cable;
wherein the first cable is configured to transmit the PCIE signal transmitted via the sixth bus to the storage resource pool.

15. The non-transitory storage system according to claim 14, further comprising:
a signal conditioning component;
wherein the signal conditioning component is configured to re-construct the PCIE signal transmitted via the first cable based on an internal clock to increase transmission energy of the PCIE signal.

16. The non-transitory storage system according to claim 15, wherein
the signal conditioning component is deployed with a signal enhancement chip; and
the signal enhancement chip is configured to split the PCIE signal into a plurality of combinations of signal channels.

17. The non-transitory storage system according to claim 16, further comprising:
a second cable;
wherein the second cable is configured to acquire a re-constructed PCIE signal and transmit the re-constructed PCIE signal to a drive backplane of the solid-state drive.

18. A method for acquiring a storage resource, applied to the non-transitory storage system according to claim 10 and comprising:
acquiring, by the plurality of computing nodes, PCIE resources stored in the storage resource pool by accessing the storage resource pool, to achieve multi-computing node sharing of the PCIE resources.

19. An electronic device, comprising: a processor, a memory, and a computer program stored in the memory and capable of running on the processor, the processor executing the computer program to implement the steps of the method for acquiring a storage resource according to claim 18.

20. A non-transitory computer-readable storage medium, having a computer program stored therein, a processor executing the computer program to implement the steps of the method for acquiring a storage resource according to claim 18.
